(19) United States
(12) Patent Application Publication
(10) Pub. No.: US 2026/0099444 A1
(43) Pub. Date: Apr. 9, 2026

(54) DATA HIERARCHICAL STORAGE

(71) Applicant: Alipay (Hangzhou) Digital Service Technology Co., Ltd., Hangzhou (CN)

(72) Inventors: Chunjie SHEN, Hangzhou (CN); Mochen BAI, Hangzhou (CN); Jiangtao ` LU, Hangzhou (CN); Ji ZHANG, Hangzhou (CN); Xudong HAN, Hangzhou (CN)

(21) Appl. No.: 19/417,236

(22) Filed: Dec. 11, 2025

Related U.S. Application Data
(63) Continuation-in-part of application No. PCT/CN2024/103629, filed on Jul. 4, 2024.

(30) Foreign Application Priority Data
Jul. 5, 2023 (CN) 202310819451.7

(51) Int. Cl. G06F 12/0811

(52) U.S. Cl. CPC G06F 12/0811; G06F 2212/604

(57) ABSTRACT

Implementations of the specification provide a method and system for hierarchical data storage, and relate to a data storage technology. Key points of the method and system for hierarchical data storage include: obtaining a current access frequency of target data based on a request for accessing the target data initiated to a first storage area and a historical access frequency of the target data, where data in the first storage area is moved from a second storage area and has a historical access frequency mark, and the historical access frequency mark reflects a historical quantity of times of requesting to access corresponding data from the first storage area; and in response to that the current access frequency is greater than a cache threshold, keeping the target data in the first storage area or migrating the target data from the second storage area to the first storage area, and updating a historical access frequency mark of the target data based on the current access frequency of the target data, where the first storage area has a larger data transmission bandwidth than the second storage area.

### TECHNICAL FIELD

The specification relates to the field of data storage technologies, and in particular, to a method and system for hierarchical data storage.

### BACKGROUND

Impact of storage of data in a computing device on computing efficiency and performance of the entire device cannot be underestimated. How to provide an efficient data storage manner is one of important issues of long-term concern to the industry. Some implementations of the specification are intended to provide a method for hierarchical data storage, to support large-capacity data storage and effectively improve data access efficiency.

### SUMMARY

One or more implementations of the specification provide a method for hierarchical data storage, performed by at least one processor. The method includes: obtaining a current access frequency of target data based on a request for accessing the target data initiated to a first storage area and a historical access frequency of the target data, where data in the first storage area is migrated from a second storage area and has a historical access frequency mark, and the historical access frequency mark reflects a historical quantity of times of requesting to access corresponding data from the first storage area; and in response to that the current access frequency is greater than a cache threshold, keeping the target data in the first storage area or migrating the target data from the second storage area to the first storage area, and updating a historical access frequency mark of the target data based on the current access frequency of the target data, where the first storage area has a larger data transmission bandwidth than the second storage area.

One or more implementations of the specification provide a system for hierarchical data storage. The system for hierarchical data storage includes: an access frequency determining module, configured to obtain a current access frequency of target data based on a request for accessing the target data initiated to a first storage area and a historical access frequency of the target data, where data in the first storage area is migrated from a second storage area and has a historical access frequency mark, and the historical access frequency mark reflects a historical quantity of times of requesting to access corresponding data from the first storage area; and a hierarchical module, configured to: in response to that the current access frequency is greater than a cache threshold, keep the target data in the first storage area or migrating the target data from the second storage area to the first storage area, and update a historical access frequency mark of the target data based on the current access frequency of the target data, where the first storage area has a larger data transmission bandwidth than the second storage area.

One or more implementations of the specification provide a storage medium, configured to store computer instructions. When at least a part of the computer instructions is executed by a processor, the above method for hierarchical data storage is implemented.

One or more implementations of the specification provide an apparatus for hierarchical data storage, including a storage medium and a processor. The storage medium stores computer instructions, and the processor is configured to execute at least a part of the computer instructions, to implement the above method for hierarchical data storage.

One or more implementations of the specification provide a storage medium, storing a cache data table. Data in the cache data table is migrated from another storage area, and a historical access frequency is greater than a cache threshold; and the data in the cache data table has a historical access frequency mark, and the historical access frequency mark reflects a historical quantity of times of requesting to access corresponding data from the cache data table.

One or more implementations of the specification provide a data access method, performed by at least one processor, and including: initiating a request for accessing target data to a first storage area; and initiating the request for accessing the target data to a second storage area if the target data does not exist in the first storage area. Accessing the data in the first storage area includes reading or writing data, and the data is hierarchically stored in the first storage area and the second storage area in the above method for hierarchical data storage.

One or more implementations of the specification provide a data access system, including: a first access module, configured to initiate a request for accessing target data to a first storage area; and a second access module, configured to initiate the request for accessing the target data to a second storage area if the target data does not exist in the first storage area. Accessing the data in the first storage area includes reading or writing data, and the data is hierarchically stored in the first storage area and the second storage area in the above method.

One or more implementations of the specification provide a storage medium, storing computer instructions. When the computer instructions are executed by a processor, the above data access method is implemented.

### BRIEF DESCRIPTION OF DRAWINGS

The specification is further described by using example implementations, and theses example implementations are described in detail with reference to the accompanying drawings. These implementations are not intended for limitation. In these implementations, same numbers represent same structures.

FIG. 1 is a schematic diagram illustrating an architecture for hierarchical data storage according to some implementations of the specification;

FIG. 2 is an example flowchart illustrating a method for hierarchical data storage according to some implementations of the specification;

FIG. 3 is a schematic diagram illustrating a data storage structure in a first storage area according to some implementations of the specification;

FIG. 4 is a schematic diagram illustrating data access according to some implementations of the specification;

FIG. 5 is an example block diagram illustrating a system for hierarchical data storage according to some implementations of the specification; and

FIG. 6 is an example block diagram illustrating a data access system according to some implementations of the specification.

### DESCRIPTION OF IMPLEMENTATIONS

To describe the technical solutions in the implementations of the specification more clearly, the following is a brief introduction of the accompanying drawings for illustrating such technical solutions. Clearly, the accompanying drawings described below are some examples of implementations of the present specification, and a person of ordinary skill in the art can further apply the present specification to other similar scenarios based on these accompanying drawings without making innovative efforts. Unless clearly learned from the language environment or otherwise stated, same numbers in the drawings represent same structures or operations.

It should be understood that the “system”, “apparatus”, “unit”, and/or “module” used herein are methods used to distinguish between different components, elements, devices, parts, or assemblies of different levels. However, if other words can achieve the same purpose, the words can be replaced by other expressions.

As shown in the specification and the claims, unless an exception is explicitly indicated in the context, the words “one”, “a”, “an”, and/or “the” do not specifically indicate singular numbers and can also include plural numbers. Generally, the terms “include” and “comprise” only indicate steps and elements that have been explicitly identified, and these steps and elements do not constitute an exclusive listing, and the method or the device can also include other steps or elements.

A flowchart is used in the specification to describe operations performed by a system according to the implementations of the specification. It should be understood that a previous or subsequent operation is not necessarily performed precisely in a sequence. Instead, steps can be processed in a reverse sequence or processed simultaneously. In addition, other operations can be added to these processes, or a step or several operations can be removed from these processes.

Data storage is closely associated with computing efficiency of a computing device. With improvement of a computational power of a processor of the computing device, data storage needs to be further optimized, to match a speed at which the processor reads or writes data, and data storage needs larger space, to meet a requirement of an increase in a scale of to-be-processed data.

A click prediction model is used as an example for illustration purposes only in the specification. The model is used to predict a probability that a product is clicked (e.g., accepted) by a user after being advertised or recommended to the user. Accurate click prediction can help an advertiser (or a product recommender) make better advertisement and product recommendation decisions, to improve a recommendation effect. Most input features, for example, features such as product numbers, user marks, and display platform (or advertisement) marks, used for click prediction are a high-dimensional sparse vector. These features are usually encoded (for example, one-hot encoded) into a vector with a large quantity of elements, and values of most elements in the vector are 0. To reduce computing complexity and storage overheads, these features in a form of a high-dimensional (for example, 256-dimensional) sparse vector are usually mapped onto a form of a low-dimensional (for example, 32-dimensional or 64-dimensional) embedded vector. Such mapping, also referred to as embedding, is a technology in which a discrete object (for example, a user, a product, or a specific feature thereof) corresponds to an element or a “point” in a continuous low-dimensional vector space (embedded vector space). In this technology, a similarity and a relationship between objects can be captured in response to that the object corresponds to the “point” in the embedded vector space, so that the similarity and the relationship between objects still remain between corresponding “points” in the embedded vector space after the objects are mapped onto the points. Therefore, the embedding technology is widely applied to machine learning, to efficiently and accurately represent an input feature required by a model, especially a sparse feature.

The embedded vector space is obtained during model training. In some implementations, the embedded vector space can be considered as a part of model parameters, and an embedded vector therein is referred to as an embedded parameter. In a training process, as the model is optimized and improved, the “points” in the embedded vector space tend to converge, and increase with a quantity of training samples and features thereof. It can be learned that, for a model, for example, a click prediction model, whose main input feature is a high-dimensional sparse feature, the model can have up to a hundred billion or even a trillion of embedded parameters, which brings huge storage pressure to a computing device. In another aspect, in an online learning scenario, because of a change in a sample data distribution, the embedded parameters of the model may continuously increase, which not only further increases storage pressure of a device, but also causes a continuous increase in memory occupation of the computing device. Consequently, a resource usage exceeds a determined threshold or quota, and a problem of out of memory (OOM) occurs. This further adversely affects performance and stability of the computing device.

In view of this, some implementations of the specification provide a method for hierarchical data storage, which supports large-capacity data storage and effectively improves data access efficiency. It should be noted that, although training of the click prediction model is used as an example for description in some implementations of the specification, this should not be construed as a limitation on an application scenario of the technical solution provided in the specification. The method for hierarchical data storage provided in the specification can be applicable to data storage and management in a computing device in any application scenario.

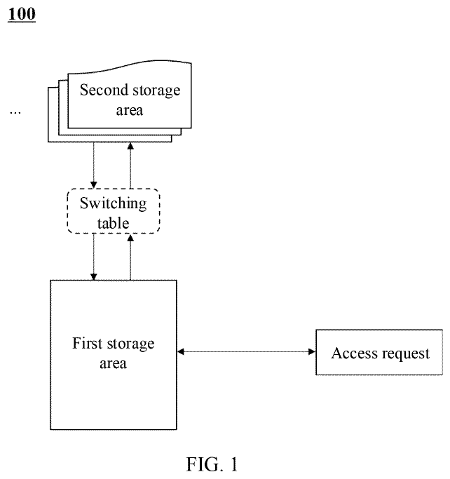

FIG. 1 is a schematic diagram illustrating an architecture for hierarchical data storage according to some implementations of the specification. In an architecture 100 for hierarchical data storage shown in FIG. 1, data is hierarchically stored in a first storage area and a second storage area. The first storage area has a larger data transmission bandwidth than the second storage area, and the data transmission bandwidth herein can be a rate at which data is read from or written to a storage. In some implementations, a computing device is a single-processor device, the first storage area can be located in a memory (MEM) of a main processor or a central processing unit (CPU), and the second storage area can be located in an external memory, for example, a solid-state disk, of the computing device. The solid-state disk, SSD for short, also referred to as a solid-state drive, is a hard disk formed by using a solid-state electronic storage chip array, and has a high data transmission bandwidth and a data storage capacity up to several T (GB). In some other implementations, the computing device is a multi-processor device, and includes a main processor and a coprocessor. The main processor is a processing core of a processing device, and is usually implemented by a general-purpose CPU. The coprocessor is scheduled by the main processor, and is configured to assist the main processor in performing some specific computing tasks, which can be implemented by a graphics processing unit (GPU), etc. A video RAM of the graphics processing unit can be a high bandwidth memory (HBM) chip, and a plurality of double data rate (DDR) storage chips are stacked together, to implement a large-capacity and high-bit-width DDR combination array. Usually, the video RAM has a larger data transmission bandwidth than the memory, and the memory has a much higher data transmission bandwidth than the hard disk. However, storage space of the video RAM, storage space of the memory, and storage space of the hard disk are in ascending order. For example, a data transmission bandwidth of the hard disk is 100 MB/s, a data transmission bandwidth of the memory can be dozens of GB/s, and a data transmission bandwidth of the video RAM can be up to hundreds of GB/s. In this case, the first storage area can be located in the video RAM of the graphics processing unit, and the second storage area can be located in the memory of the central processing unit. In the multi-processor device, the first storage area can also be located in the memory of the central processing unit, and the second storage area is still located in the external memory, for example, the hard disk.

The first storage area and the second storage area can be a segment of physical storage area in a corresponding storage or storage chip. In some implementations, the first storage area and the second storage area each can be represented in a form of a data table, for example, a hash table.

As described above, a capacity of the storage changes in a negative relation to a data transmission bandwidth of the storage. Therefore, in some implementations, a data volume of the first storage area does not exceed a data volume of the second storage area. For example, data in the first storage area can be migrated from the second storage area. Usually, data frequently requested to be accessed by the processor is stored in the first storage area, and data with a low access frequency is kept in the second storage area. A click prediction model is used as an example. Large-scale embedded parameters of the click prediction model can be stored in a memory with a large storage capacity, and a frequently accessed embedded parameter can be stored in a memory with a large data transmission bandwidth, to support large-capacity storage of the embedded parameters, and effectively improve data access efficiency.

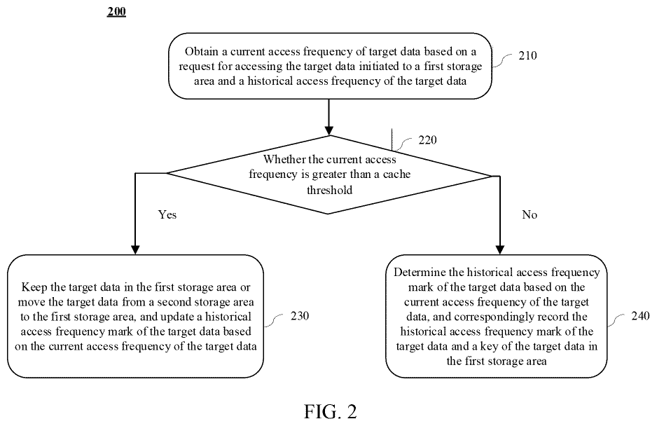

FIG. 2 is an example flowchart illustrating a method for hierarchical data storage according to some implementations of the specification. A method for hierarchical data storage is further provided based on the storage partitioning architecture shown in FIG. 1. In some implementations, a procedure 200 shown in FIG. 2 can be implemented by at least one processor (for example, a central processing unit or a graphics processing unit), for example, can be implemented by a system 500 for hierarchical data storage (or briefly referred to as a system 500) on the processor. The procedure 200 in FIG. 2 can include the following steps.

Step 210: Obtain a current access frequency of target data based on a request for accessing the target data initiated to a first storage area and a historical access frequency of the target data. In some implementations, step 210 can be implemented by an access frequency determining module 510.

Accessing can be reading or writing data, and writing includes inserting new data or changing a value of existing data. The access request can be initiated by the processor, and can be, for example, initiated by a thread, for example, a training thread, a data access thread, or a computing result writing thread, that runs on the processor. The request for accessing the target data is first initiated to the first storage area. In this case, the target data may or may not be stored in the first storage area. However, regardless of whether the target data is accessed, an access frequency of one time is recorded. Therefore, the target data has the historical access frequency, which reflects a quantity of times of requesting to access the target data from the first storage area. The historical access frequency may be determined in various ways, which are all included in the scope of the disclosure. For example, the historical access frequency may be determined as an average number of access requests for a determined time period, a highest number of access requests in an unit of time within a determined time period, or a smallest number of access requests in an unit of time within a determined time period, or other measures of the quantity of times of requesting to access the target data. In some implementations, an additional data table, for example, a metadata table, can be maintained, to record a historical access frequency of requesting to access data from the first storage area. In some other implementations, data in the first storage area can have a historical access frequency mark, to record a quantity of times of requesting to access the data from the first storage area. The adjacency data mark can be a symbol or a number that reflects the quantity of times, or can be a pointer or an address that points to a value of a corresponding quantity of times. In some implementations, regardless of whether accessed data is stored in the first storage space, a historical access frequency mark of the accessed data can be recorded in the first storage space. For example, a key of data and a historical access frequency mark of the data can be correspondingly stored in the first storage space. The key of the data can be a field name of the data, a hash value of a value of the data, etc.

The current access frequency of the target data can be obtained based on the current access request and the historical access frequency of the target data. For example, the historical access frequency of the target data can be obtained by querying the metadata table or the first storage area, and the current access frequency of the target data is obtained by adding 1 (e.g., a quantity of times that the current access request contributes) to the historical access frequency. For example, the current access frequency is 6 if the historical access frequency of the target data is 5. For another example, the current access frequency is 1 in response to that the historical access frequency of the target data is 0, that is, the first storage area is never requested to be accessed for the corresponding data. For another example, the current access frequency can be determined based on an accumulated number of access requests in a determined unit of time and the historical access frequency. For example, the accumulated number of access requests can be added to the historical access frequency to obtain the current access frequency.

In some implementations, the determination of one or more of the current access frequency and the historical access gives weights to the quantity of access requests in various time periods. Quantity of access requests in a more recent time period can be assigned a greater weight than a quantity of access requests in an earlier time period.

Step 220: Determine whether the current access frequency is greater than a cache threshold; and perform step 230 if yes, or perform step 240 if not. In some implementations, step 220 can be implemented by a hierarchical module 520.

Step 230: Allocate the target data to the first storage area. In some implementations, in a case that the target data is already in the first storage area, the target data remains kept in the first storage area. In a case that the target data is not currently in the first storage area, the allocation includes moving, e.g., migrating, the target data from another storage area, e.g., the second storage area, to the first storage area, and update a historical access frequency mark of the target data based on the current access frequency of the target data. In some implementations, step 230 can be implemented by the hierarchical module 520.

The cache threshold can be a determined constant, for example, 50 or 200, or can be a variable, for example, can be a smallest historical access frequency of the data in the first storage area.

In response to that the current access frequency is greater than the cache threshold, it can be considered that the access frequency of the target data is high, and the target data is hot data and can be stored in the first storage area. For example, the current access frequency is obtained through successive accumulation. Therefore, in response to that the current access frequency is clearly higher than the cache threshold, it indicates that the target data has been in the first storage area. In this case, the target data does not need to be migrated. It can be understood that the target data continues to be kept in the first storage area, and the historical access frequency mark of the target data is updated based on the current access frequency. For example, the historical access frequency mark of the target data is 10, and the current access frequency mark is 11. If the cache threshold is set to 5, the target data continues to be kept in the first storage area, and the historical access frequency mark of the target data is updated from original 10 to 11.

In response to that the current amount of access, e.g., access frequency or other measures of access amount, meets the cache threshold, e.g., is greater than the cache threshold by one, and the target data is currently not in the first storage area. In this case, it can be considered as a critical state, and the target data is to be migrated from the second storage area to the first storage area. For example, a value of the target data can be read from the second storage area by using a field name or a key of the target data as a query condition, and the value is written to the first storage area. In addition, the historical access frequency mark of the target data is determined based on the current access frequency mark, and is stored in the first storage area together. In some implementations, the first storage area has pre-stored the historical access frequency mark of the target data. In this case, the historical access frequency mark merely needs to be updated based on the current access frequency.

In some implementations, the cache threshold can be dynamically adjusted.

For “migration” or “move” mentioned in some implementations of the specification, data in an original storage area (for example, the second storage area) may be deleted; or may not be deleted, and may remain in the original storage area to be used as a backup. “Keep” mentioned in some implementations of the specification can be understood broadly. That is, the data can be “archived” in the first storage area, but it does not necessarily mean that a value of the data is constant. For example, the data is stored in the first storage area in a form of a key-value pair (key: value). “Keep” can be understood as that a key of the data remains unchanged, and the value of the data is stored in the first storage area, but the value can be updated.

In some implementations, in response to that the first storage area is not full, data that is to be migrated in can be directly written to the first storage area. After the first storage area is full, some data in the first storage area can be first migrated out, to accommodate newly migrated-in data. In some implementations, pieces of data with smallest historical access frequencies will be candidates to be removed from the first storage area. In some implementations, an age of a piece of data in the first storage area can also be considered. Between two pieces of data that have a same historical access frequency, the one that stays longer in the first storage area may be first removed. In some implementations, at least one piece of data whose historical access frequency is equal to or lower than the cache threshold (e.g., elevated cache threshold) in the first storage area can be removed from the first storage area. For example, a part of the data can be removed, or all of the data can be removed. In response to that the cache threshold is the smallest historical access frequency of the data in the first storage area, after the above data is removed, the cache threshold changes, for example, is increased by 1. For example, the removed data is migrated back to the second storage area.

In some other implementations, the first storage area is full at an initial stage. For example, a part of data can be randomly selected from the second storage area, and is written to the first storage area. In response to that new data needs to be migrated in, the at least one piece of data is removed in the above manner, and is migrated back to the second storage area.

In some implementations, data to be migrated to the first storage area and data to be migrated back to the second storage area can be recorded in a switching table. Recording can be understood as temporarily storing the data in the switching table, or can be understood as recording a mark of the data only in the switching table. For example, data to be migrated back to the second storage area can be removed from the first storage area and stored in the switching table. After a threshold data volume of to-be-migrated-back data is accumulated in the switching table, the data is migrated back to the second storage area. For another example, the data to be migrated to the first storage area can be stored in the switching table from the second storage area. After a threshold data volume of to-be-migrated-in data is accumulated in the switching table, the data is migrated to the first storage area together. Alternatively or additionally, a total data volume of the to-be-migrated-in data and the to-be-migrated-back data in the switching table is counted, and after the total data volume reaches a specified threshold, migration-in and migration-back are separately performed. In some other implementations, only a mark of to-be-migrated-in data and a mark of to-be-migrated-back data, for example, a field name or a key, can be recorded in the switching table. After the data volume reaches the specified threshold, a value of corresponding data is migrated from the second storage area to the first storage area, and/or a value of corresponding data is migrated back from the first storage area to the second storage area. Only the adjacency data mark of the data is recorded in the switching table, which helps reduce storage overheads of the switching table and reduces data switching amount.

Step 240: Determine the historical access frequency mark of the target data based on the current access frequency of the target data, and correspondingly record the historical access frequency mark of the target data and a key of the target data in the first storage area. In some implementations, step 240 can be implemented by the hierarchical module 520.

In some implementations, in response to that the current access frequency is not greater than the cache threshold, the target data does not need to be migrated from the second storage area to the first storage area, but the historical access frequency mark of the target data can be recorded in the first storage area. Content of recording and maintaining a historical access frequency mark of each piece of data in the first storage area can be further found in related descriptions in step 210.

Both the historical access frequency and the current access frequency reflect a quantity of times of accessing the target data from the first storage area. Through comparison with the cache threshold, high-heat data is migrated from the second storage area to the first storage area, thereby implementing hierarchical data storage.

In some implementations, the data in the first storage area can be stored in a form of a key-value pair. That is, one piece of data includes a key and a value. For example, the key can be information that uniquely identifies the data, for example, an ID, a field name, or a hash value of the value. For example, the key can be Tim, and the value can be 138xxxx1234. For another example, the key can be a hash value of an embedded parameter, and the value is the embedded parameter. In response to that the data in the first storage area is stored in a form of a key-value pair, the data in the first storage area can form a hash table. The data can be directly accessed based on the key of the data. Spatial complexity is O (1). This improves access efficiency.

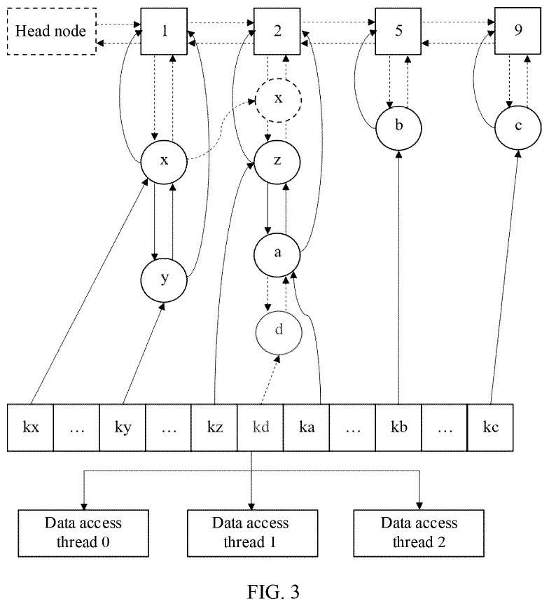

In some implementations, the first storage area can further record data and a historical access frequency mark of the data. FIG. 3 is a schematic diagram illustrating a data storage structure in a first storage area according to some implementations of the specification. As shown in FIG. 3, the data in the first storage area can be stored in a combination of a hash table and a linked list. For example, the data in the first storage area is first stored in a form of a key-value pair, for example, kx: x, ky: y, . . . where kx, ky, . . . are keys, and x, y, . . . are values. The historical access frequency mark of each piece of data can be an address or a pointer, and points to a corresponding frequency value (for example, a data value x points to an arrow of a frequency value 1). For example, the historical access frequency mark is a storage address corresponding to the frequency value. Values 1, 2, 5, and 9 in FIG. 3 are frequency values, a historical access frequency of data kx: x and ky: y is 1, and a historical access frequency of data kz: z and ka: a is 2. In some implementations, the data in the first storage area further has an adjacency data mark of the data, adjacency data of the data includes upstream data and downstream data of the data, and the data and the adjacency data of the data have the same historical access frequency. The adjacency data mark can be an address or a pointer, for example, a storage address of the upstream data or the downstream data of the data. Data with the same historical access frequency are linked together based on the adjacency data mark, for example, z-a and x-y in FIG. 3. In some implementations, the frequency value can also be considered as a link between a data node and the data in the first storage area. As such, data having the same historical access frequency and the historical access frequency value of such data can form a frequency value linked list, for example, a linked list 1-x-y and a linked list 5-b. Frequency values 1 and 2 can be respectively used as head nodes of a frequency value linked list in which the frequency values are located. In some other implementations, all frequency values can alternatively form a linked list, for example, a linked list Head node-1-2-5-9 in FIG. 3.

Based on the data storage structure shown in FIG. 3, the keeping the target data in the first storage area, and updating the historical access frequency mark of the target data based on the current access frequency of the target data can further include: modifying an adjacency data mark of adjacency data of the target data based on an adjacency data mark of the target data, to directly connect upstream data and downstream data of the target data; and modifying the historical access frequency mark and the adjacency data mark of the target data, to remove the target data from an original frequency value linked list, and adding the target data to a frequency value linked list corresponding to the current access frequency.

With reference to FIG. 3, the following describes in detail how to update the historical access frequency mark of the target data based on the current access frequency of the target data (it is assumed that the target data has been in the first storage area). x is used as an illustrative example piece of data. A historical access frequency of x is 1, and a current access frequency is 2. In this case, the data x needs to be removed from a linked list corresponding to the frequency value 1, and added to a linked list corresponding to the frequency value 2. An adjacency data mark of adjacency data, e.g., the frequency value 1 and data y, of the target data x can be modified based on an adjacency data mark of the target data x, to directly connect upstream data (the frequency value 1) of the target data x and downstream data (the data y). For example, an upstream data mark of the data y can be modified to an upstream data mark of the data x, and a downstream data mark of the frequency value 1 can be modified to a downstream data mark of the data x. As such, the data y and the frequency value 1 are directly connected by “skipping” the data x. Then, the historical access frequency mark of the data x is modified, so that the historical access frequency mark of the data x points to the frequency value 2. The adjacency data mark of the data x is modified and added to the linked list corresponding to the frequency value 2. To reduce computing overheads, the data x can be added to a first position or a last position in a corresponding frequency value linked list. For example, the downstream data mark of the data x can be updated to a storage address of head data, e.g., z, in a linked list of the frequency value 2, and the upstream data mark of the data x can be updated to a storage address of the frequency value 2. Actually, a historical data access mark of the data x is updated to the storage address of the frequency value 2. Therefore, the upstream data mark of the data x can be directly cleared. Correspondingly, an upstream data mark of data z is updated to a storage address of the data x. For example, a downstream data mark of the frequency value 2 is updated to the storage address of the data x. Alternatively or additionally, an upstream data mark of the data x can be updated to a storage address of tail data, e.g., a, in a linked list of the frequency value 2, and a downstream data mark of the data x is cleared. Correspondingly, a downstream data mark of the data a is updated to a storage address of the data x. So far, the data x is removed from the linked list corresponding to the frequency value 1, and added to the linked list corresponding to the frequency value 2.

Based on the data storage structure shown in FIG. 3, the migrating the target data from the second storage area to the first storage area, and updating a historical access frequency mark of the target data based on the current access frequency of the target data includes: migrating a value of the target data from the second storage area, and correspondingly storing the value of the target data and a key of the target data in the first storage area; enabling the historical access frequency mark of the target data to point to a frequency value corresponding to the current access frequency; and adding an adjacency data mark to the target data, so that an upstream data mark of the target data points to tail data in a linked list of the frequency value, or a downstream data mark of the target data points to head data in a linked list of the frequency value.

With reference to FIG. 3, the following describes in detail how to migrate the target data to the first storage area, and update the historical access frequency mark of the target data based on the current access frequency. Data d is used as an example. The data d comes from the second storage area, a value d and a key kd are correspondingly stored in the first storage area, and a historical access frequency mark, for example, a storage address of a frequency value corresponding to a current access frequency, is added to the data d. As described in step 210, in some implementations, the first storage area has pre-stored a historical access frequency mark of data for which an access request is once initiated to the first storage area. In this case, the historical access frequency mark of the data d can be updated, so that the historical access frequency mark of the data d points to a frequency value, for example, 2, corresponding to the current access frequency. Further, the data d needs to be added to a frequency value linked list corresponding to the frequency value 2. For example, an upstream data mark, for example, a storage address of the tail data a in the linked list, can be added to the data d, so that the data d is used as new tail data in the linked list of the frequency value 2. Further, the downstream data mark can be added to the data d, and the downstream data mark can be a null value. Correspondingly, a downstream data mark of the data a, for example, a storage address of the data d, is modified. Alternatively or additionally, a downstream data mark, for example, a storage address of head data z in the linked list, can be added to the data d, and the data d is used as new head data in the linked list of the frequency value 2. For example, an upstream data mark, for example, a storage address of the frequency value 2, can be added to the data d. Correspondingly, the upstream data mark of the data z, for example, the storage address of the data d, is modified. For example, the downstream data mark of the frequency value 2 is modified to the storage address of the data d. So far, the data d is added to the linked list corresponding to the frequency value 2.

Based on the data storage structure shown in FIG. 3, the removing the at least one piece of data whose historical access frequency is equal to the cache threshold in the first storage area from the first storage area includes: for each of the at least one piece of data: modifying an adjacency data mark of adjacency data of the piece of data, to remove the piece of data from a frequency value linked list of the piece of data; and deleting a value and an adjacency data mark of the piece of data.

With reference to FIG. 3, the following describes in detail how to remove at least one piece of data whose historical access frequency is equal to the cache threshold in the first storage area from the first storage area. To reduce computing overheads, data can be removed starting from tail data in a linked list corresponding to a frequency value equal to the cache threshold. The data y is used as an example. A downstream data mark of upstream data x of the data y is modified to a null value, and a value y and an adjacency data mark of the data y are deleted. In some implementations, other data can be deleted from a linked list corresponding to a frequency value equal to the cache threshold. For example, the data x is deleted. A downstream data mark of an upstream data frequency value 1 of the data x is modified to a downstream data mark of the data x, for example, a storage address of the data y, and an upstream data mark of downstream data y of the data x is modified to an upstream data mark of the data x, for example, a storage address of the frequency value 1, and finally a value y and an adjacency data mark of the data y are deleted.

It can be learned, from the above process of updating the historical access frequency mark based on the data structure shown in FIG. 3, and migrating the target data to the first storage area or removing the target data from the first storage area, that only a constant quantity of steps are needed, spatial complexity is still O (1) and does not increase with a data volume in the first storage area, and processing efficiency is high. Such a processing efficiency advantage is more prominent as the data volume increases.

Some implementations of the specification provide a data access method. The method includes: initiating a request for accessing target data to a first storage area; and initiating the request for accessing the target data to a second storage area if the target data does not exist in the first storage area.

Accessing the data in the first storage area includes reading or writing data. In some implementations, the data is stored in a form of a key-value pair, and the accessing can include: reading or updating (that is, writing) a value of the data based on a key of the target data. Writing can further include: adding new data in a form of a key-value pair.

In some implementations, the first storage area is located in a memory of a central processing unit, the second storage area is located in a hard disk, and data in the first storage area and the second storage area can include an embedded parameter of a model. A model training task runs in a GPU of a multi-processor device. The GPU can be, for example, a data access thread on the GPU. An embedded parameter in the first storage area or the second storage area is read in the above data access method for computing, for example, model training, and a computing result, for example, a model parameter obtained through training and updating, is written to the first storage area or the second storage area. In a data access process, data is also migrated in the first storage area and the second storage area based on a procedure shown in FIG. 2, and finally, a hierarchical storage structure, or referred to as double-layer storage, is formed.

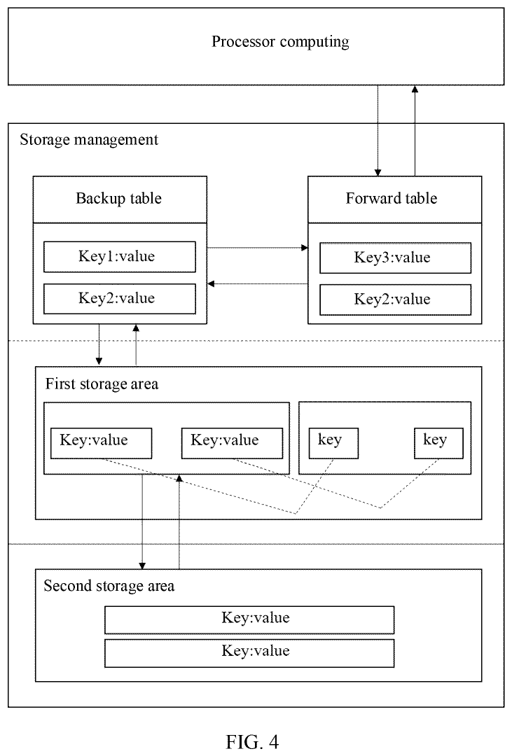

As shown in FIG. 4, in some implementations, two data tables, namely, a forward table and a backup table, can be set in a video RAM of the GPU, and can be, for example, hash tables. A data access thread in the GPU can request a needed embedded parameter from double-layer storage based on a training task, for example, obtain embedded parameters of a sample 1 to a sample 1000, cache read data in the backup table, and read at least partial data, for example, the samples 1 to 100 (which are used as a training batch), in the backup table to the forward table. A training thread of the GPU directly reads data in the forward table for model training. With model training, model parameters including the embedded parameters are updated, and an updated model parameter is written to the forward table as a computing result. A writing process includes: updating a value of an existing model parameter based on a key of the existing model parameter, or adding a new model parameter in a form of a key-value pair. Thereafter, the backup table is updated based on the forward table, the backup table and the forward table are synchronized, and finally, the double-layer storage is updated based on the backup table. The updating includes: changing a value of existing data in original storage, or adding a new key-value pair. In some implementations, a time threshold can be set for updating of each level of storage, so that each level of storage periodically updates and synchronizes the data based on the time threshold. In some implementations, a dual-table pipeline can be set to automatically maintain and update the forward table and the backup table periodically.

In some implementations of the specification, two data tables are set, to further increase storage layers, and meet a requirement for accessing data at a high speed by a processor.

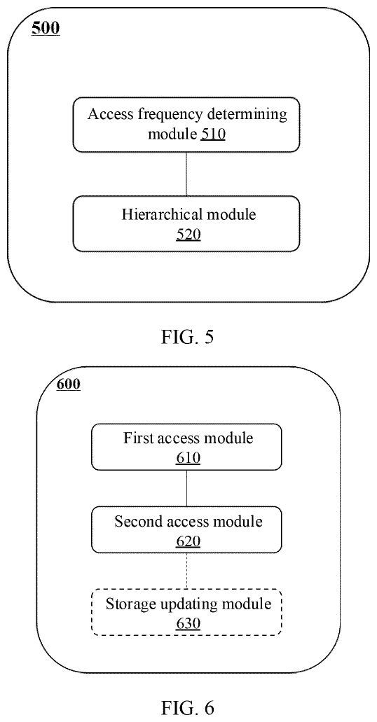

As shown in FIG. 5, some implementations of the specification provide a system for hierarchical data storage (or referred to as a system 500 for short), and the system 500 includes an access frequency determining module 510 and a hierarchical module 520.

The access frequency determining module 510 is configured to obtain a current access frequency of target data based on a request for accessing the target data initiated to a first storage area and a historical access frequency of the target data. Data in the first storage area is migrated from a second storage area and has a historical access frequency mark, and the historical access frequency mark reflects a historical quantity of times of requesting to access corresponding data from the first storage area.

The hierarchical module 520 is configured to: in response to that the current access frequency is greater than a cache threshold, keep the target data in the first storage area or migrating the target data from the second storage area to the first storage area, and determine to update a historical access frequency mark of the target data based on the current access frequency of the target data. The first storage area has a larger data transmission bandwidth than the second storage area.

Some implementations of the specification further provide a data access system. As shown in FIG. 6, a system 600 includes a first access module 610 and a second access module 620.

The first access module 610 is configured to initiate a request for accessing target data to a first storage area.

The second access module 620 is configured to initiate the request for accessing the target data to a second storage area if the target data does not exist in the first storage area.

In some optional implementations, the system 600 further includes a storage updating module 630. The storage updating module 630 is configured to: record the read target data in a backup table; obtain at least partial data from the backup table, and store the at least partial data in a forward table for computing by a processor; update the forward table based on a computing result; update the backup table based on the forward table; and update one or more of the first storage area or the second storage area based on the backup table. The updating includes updating a value of original data or writing new data.

For more content of modules in the system 500 and the system 600, references can be made to related descriptions in FIG. 2 and FIG. 4. Details are omitted herein. It should be understood that the systems and modules shown in FIG. 5 and FIG. 6 can be implemented in various manners. For example, in some implementations, the system and modules of the system may be implemented by hardware, software, or a combination of software and hardware. The hardware part may be implemented by using dedicated logic. The software part may be stored in a storage and executed by an appropriate instruction execution system, such as a microprocessor or specially designed hardware. In some implementations, the above modules can be implemented by using computer code. When the computer code is executed, a client can be represented as a function body and an interface thereof, and a server can be represented as an independent process. A person skilled in the art may understand that the foregoing method and system may be implemented by using computer-executable instructions and/or control code included in the processor, for example, such code is provided on a carrier medium such as a disk, a CD, or a DVD-ROM, a programmable memory such as a read-only memory (firmware), or a data carrier such as an optical or electronic signal carrier. The system and the modules of the system in the specification may be implemented not only by a hardware circuit of an ultra-large-scale integrated circuit or gate array, a semiconductor such as a logic chip or a transistor, or a programmable hardware device such as a field programmable gate array or a programmable logic device, but also by software executed by various types of processors, or may be implemented by a combination of the hardware circuit and software (for example, firmware).

It should be noted that the above descriptions of the system and the modules of the system are merely for ease of description, and cannot limit the specification within the scope of the illustrated implementations. It can be understood that, after understanding the principle of the system, a person skilled in the art may arbitrarily combine the modules or form a subsystem to connect to other modules without departing from this principle. Alternatively or additionally, some modules are split, to obtain more modules or a plurality of units of the modules. Such changes fall within the protection scope of the specification.

Some implementations of the specification further provide a storage medium, storing a cache data table. Data in the cache data table is migrated from another storage area, and a historical access frequency is greater than a cache threshold; and the data in the cache data table has a historical access frequency mark, and the historical access frequency mark reflects a historical quantity of times of requesting to access corresponding data from the cache data table.

In some implementations, the data in the cache data table is stored in a form of a key-value pair; the data in the cache data table further has an adjacency data mark of the data, adjacency data of the data includes upstream data and downstream data of the data, and the data and the adjacency data of the data have the same historical access frequency; the cache data table further includes a key and a historical access frequency mark of data whose historical access frequency is not greater than the cache threshold; and the adjacency data mark includes a pointer, and data with the same historical access frequency and the historical access frequency value of such data form a frequency value linked list.

For more content about the structure of the cache data table, references can be made to related descriptions in FIG. 3. Details are omitted herein.

Possible beneficial effects of the implementations of the specification include but are not limited to: (1) hierarchical storage is used, and data access efficiency is improved while a data storage capacity is increased. (2) A data storage architecture in which a hash table and a linked list are combined, and spatial complexity of an add, delete, query, or modify operation is O (1), thereby greatly improving data access efficiency and a throughput. (3) Data hierarchical migration is implemented automatically and in real time in a data access process, and a memory capacity is considered.

Basic concepts have been described above. Clearly, for a person skilled in the art, the foregoing detailed disclosure is merely an example, but does not constitute a limitation on the specification. Although not explicitly stated herein, a person skilled in the art may make various modifications, improvements, and amendments to the specification. Such modifications, improvements, and amendments are proposed in the specification. Therefore, such modifications, improvements, and amendments still fall within the spirit and scope of the example implementations of the specification.

Described embodiments of the subject matter can include one or more features, alone or in combination. For example, in an embodiment, a storage medium stores a cache data table, data in the cache data table being moved from another storage area, and a historical access frequency being greater than a cache threshold. The data in the cache data table each has a historical access frequency mark, and the historical access frequency mark reflects a historical quantity of times of requesting to access corresponding data from the cache data table. The data in the cache data table is stored in a form of a key-value pair. The data in the cache data table further has an adjacency data mark of the data, adjacency data of the data includes one or more of upstream data or downstream data of the data, and the data and the adjacency data of the data have a same historical access frequency.

The cache data table further includes a key and a historical access frequency mark of data whose historical access frequency is not greater than the cache threshold. The adjacency data mark includes a pointer, and data with a same historical access frequency and the historical access frequency value of such data form a frequency value linked list.

In an embodiment, a data access method includes: initiating a request for accessing target data to a first storage area; and initiating the request for accessing the target data to a second storage area if the target data does not exist in the first storage area. The accessing the data in the first storage area includes reading or writing data, and the data is hierarchically stored in the first storage area and the second storage area in the method according to techniques described herein.

The data access method further includes: recording the read target data in a backup table; obtaining at least partial data from the backup table, and storing the at least partial data in a forward table for computing by the processor; updating the forward table based on a computing result; updating the backup table based on the forward table; and updating one or more of the first storage area or the second storage area based on the backup table. The updating includes updating a value of original data or writing new data.

The forward table and the backup table are located in a video RAM of a graphics processing unit, and the first storage area is located in a memory of a central processing unit, and the second storage area is located in a hard disk.

In the data access method, the computing includes model training. The data or the target data is an embedding feature in a form of a key-value pair, and the computing result includes an embedding feature of only one or more of an updated value or an embedding feature in a form of a newly added key-value pair.

In an embodiment, a data access system includes a first access module, configured to initiate a request for accessing target data to a first storage area; and a second access module, configured to initiate the request for accessing the target data to a second storage area if the target data does not exist in the first storage area. The accessing the data in the first storage area includes reading or writing data, and the data is hierarchically stored in the first storage area and the second storage area according to techniques described herein.

In addition, specific words are used in the specification to describe the implementations of the specification. For example, “one implementation”, “an implementation”, and/or “some implementations” mean a feature, structure, or characteristic related to at least one implementation of the specification. Therefore, it should be emphasized and noted that “an implementation”, “one implementation” or “an alternative implementation” mentioned twice or more times in different locations in the specification does not necessarily refer to the same implementation. In addition, some features, structures, or characteristics in one or more implementations of the specification may be appropriately combined.

In addition, unless explicitly stated in the claims, the order of the processing elements and sequences, the use of numbers and letters, or the use of other names described in the specification is not intended to limit the order of the procedures and methods described in the specification. Although some currently considered useful implementations of the invention are discussed in various examples in the foregoing disclosure, it should be understood that such details are merely used for illustrative purposes. The appended claims are not limited to the disclosed implementations, and instead, the claims are intended to cover all amendments and equivalent combinations that conform to the essence and scope of the implementations of the specification. For example, although the system components described above may be implemented by a hardware device, the system components may also be implemented only by a software solution, for example, installing the described system on an existing server or mobile device.

Similarly, it should be noted that, to simplify the description disclosed in the specification to help understand one or more implementations of the present invention, in the foregoing description of the implementations of the specification, a plurality of features are sometimes incorporated into one implementation or accompanying drawing or descriptions thereof. However, this disclosure method does not mean that features required by the object in the specification are more than the features mentioned in the claims. Actually, the features of the implementations are less than all features of an individual implementation disclosed above.

Numbers describing the composition and attributes are used in some implementations. It should be understood that such numbers used for the description of the implementations are modified in some examples by modifiers such as “about”, “approximately”, or “generally”. Unless otherwise stated, “about”, “approximately”, or “generally” indicates that the number allows a change in ±20%. Correspondingly, in some implementations, numeric parameters used in the specification and claims are approximations, and the approximations may change based on features required by some implementations. In some implementations, the numeric parameters should take into account the specified significant digits and use a general digit retention method. Although in some implementations of the specification, numeric domains and parameters used to determine the ranges of the implementations are approximations, in specific implementations, such values are set as precisely as possible in a feasible range.

In a typical configuration, the computer includes one or more processors (CPUs), one or more input/output interfaces, one or more network interfaces, and one or more memories. The one or more processors may be configured to individually or collectively conduct actions to implement the solutions provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the solutions provided herein. When the one or more memory devices collectively store computer executable instructions, they may or may not store the same instruction or same part of an instruction at a same time and they may store different instructions or different parts of an instruction collectively.

Each patent, patent application, and patent application publication, and other materials, such as articles, books, instructions, publications, documents, etc. that are referenced by the specification are incorporated into the specification herein by reference in its entirety, except for the application history documents that are inconsistent with or conflict with the content of the specification, and the documents limiting a widest scope of the claims of the specification (the documents currently or later attached to the specification). It should be noted that, if the description, definition, and/or use of a term in the auxiliary material of the specification is inconsistent or conflicts with the content of the specification, the description, definition, and/or use of the term in the specification shall prevail.

Finally, it should be understood that the implementations described in the specification are merely used to describe the principles of the implementations of the specification. Other variations may all fall within the scope of the specification. Therefore, as an example rather than a limitation, alternative configurations of the implementations of the specification may be considered to be consistent with the teachings of the specification. Correspondingly, the implementations of the specification are not limited to the implementations explicitly introduced and described in the specification.

What is claimed is:

1. A computer-implemented method for hierarchical data storage, comprising:
obtaining a current access frequency of target data and a historical access frequency of the target data, a piece of data in the first storage area having a historical access frequency mark, and the historical access frequency mark indicating a historical quantity of times of requesting to access the piece of data from the first storage area; and
in response to that the current access frequency is greater than a cache threshold, allocating the target data to the first storage area, and updating a historical access frequency mark and an adjacency data mark of the target data based on the current access frequency of the target data,
wherein the first storage area has a larger data transmission bandwidth than the second storage area.

2. The method according to claim 1, wherein the allocating the target data to the first storage area includes moving the target data from a second storage area to the first storage area in response to that the current access frequency is greater than the cache threshold by one.

3. The method according to claim 1, wherein the allocating the target data to the first storage area includes moving the target data from a second storage area to the first storage area, and
the method further comprises:
in response to that the first storage area is full and before the target data is moved from the second storage area to the first storage area, removing at least one piece of data whose historical access frequency is smallest among all data in the first storage area, and moving the at least one piece of data with whose historical access frequency smallest among all data in the first storage area to the second storage area.

4. The method according to claim 1, wherein the data in the first storage area is stored in a form of a key-value pair, a piece of data of the data in the first storage area further has an adjacency data mark of the piece of data, the adjacency data mark indicating adjacency data of the piece of data, the adjacency data of the piece of the data includes one or more of upstream data or downstream data of the piece of data, and the piece of data and the adjacency data of the piece of data have a same historical access frequency; and
the adjacency data mark includes a pointer indicating the adjacency data, and data with a same historical access frequency value are linked as a frequency value linked list based on the same historical access frequency value.

5. The method according to claim 4, wherein the allocating the target data to the first storage area includes keeping the target data in the first storage area, and
the updating the historical access frequency mark of the target data based on the current access frequency of the target data includes:
modifying an adjacency data mark of adjacency data of the target data based on an adjacency data mark of the target data, to link upstream data and downstream data of the target data;
modifying the historical access frequency mark and the adjacency data mark of the target data, to remove the target data from a previous frequency value linked list, and adding the target data to a frequency value linked list corresponding to the current access frequency; and
modifying an adjacency data mark of current adjacency data of the target data, so that the adjacency data mark of the current adjacency data of the target data points to the target data.

6. The method according to claim 5, wherein the modifying the historical access frequency mark and the adjacency data mark of the target data, to remove the target data from the previous frequency value linked list, and adding the target data to the frequency value linked list corresponding to the current access frequency includes:
modifying the historical access frequency mark of the target data, to point to a frequency value corresponding to the current access frequency; and
modifying the adjacency data mark of the target data, so that:
an upstream data mark of the adjacency data mark of the target data points to tail data in the frequency value linked list corresponding to the current access frequency and a downstream data mark of the adjacency data mark of the target data is cleared, or
the downstream data mark of the target data points to head data in the frequency value linked list corresponding to the current access frequency and the upstream data mark of the target data is cleared, or
the upstream data mark of the target data points to the current access frequency value.

7. The method according to claim 4, wherein the moving the target data from the second storage area to the first storage area, and updating a historical access frequency mark of the target data based on the current access frequency of the target data includes:
storing a value of the target data and a key of the target data in the first storage area;
enabling the historical access frequency mark of the target data to point to a frequency value of the current access frequency;
adding an adjacency data mark to the target data, an upstream data mark of the adjacency data mark of the target data pointing to tail data in a linked list of the frequency value, or a downstream data mark of the adjacency data mark of the target data pointing to head data in the linked list of the frequency value; and
modifying an adjacency data mark of current adjacency data of the target data, a downstream data mark or an upstream data mark of the adjacency data mark of the current adjacency data of the target data pointing to the target data.

8. The method according to claim 4, wherein the removing the at least one piece of data whose historical access frequency is smallest among all data in the first storage area from the first storage area includes:
for each piece of removed data of the at least one piece of data removed:
modifying an adjacency data mark of adjacency data of the piece of removed data, to remove the piece of removed data from a frequency value linked list of the piece of removed data; and
deleting a value and an adjacency data mark of the piece of removed data.

9. The method according to claim 1, further comprising:
in response to that the current access frequency is not greater than the cache threshold, updating the historical access frequency mark of the target data based on the current access frequency of the target data, and recording the historical access frequency mark of the target data and a key of the target data in the first storage area.

10. The method according to claim 9, comprising querying the historical access frequency mark of the target data in the first storage area based on the key of the target data.

11. The method according to claim 1, further comprising:
recording, in a switching table, data to be moved to the first storage area and data to be moved out of to the first storage area; and
in response to that one or more of an amount of data to be moved to the first storage area or an amount of data to be moved out of the first storage area is greater than a respective threshold, one or more of moving the data to be moved to the first storage area to the first storage area or moving the data to be moved out of the first storage area to a second storage area.

12. The method according to claim 2, wherein the first storage area is located in a memory of a central processing unit, and the second storage area is located in a hard disk; or
wherein the first storage area is located in a video RAM of a graphics processing unit, and the second storage area is located in a memory of a central processing unit.

13. The method according to claim 1, wherein the cache threshold is a smallest historical access frequency of the data in the first storage area.

14. The method according to claim 1, wherein the data in the first storage area is stored in a form of a key-value pair, and accessing the data in the first storage area includes reading or writing a value of the data based on a key of the data.

15. A computing system for hierarchical data storage, comprising one or more processors and one or more memory devices, the one or more memory devices, individually or collectively, having computer executable instructions stored thereon, the computer executable instructions when executed by the one or more processors, enabling the one or more processors to, individually or collectively, implement acts including:
obtaining a current access frequency of target data and a historical access frequency of the target data, a piece of data in the first storage area having a historical access frequency mark, and the historical access frequency mark indicating a historical quantity of times of requesting to access the piece of data from the first storage area; and
in response to that the current access frequency is greater than a cache threshold, allocating the target data to the first storage area, and updating a historical access frequency mark and an adjacency data mark of the target data based on the current access frequency of the target data,
wherein the first storage area has a larger data transmission bandwidth than the second storage area.

16. The computing system according to claim 15, wherein the data in the first storage area is stored in a form of a key-value pair, a piece of data of the data in the first storage area further has an adjacency data mark of the piece of data, the adjacency data mark indicating adjacency data of the piece of data, the adjacency data of the piece of the data includes one or more of upstream data or downstream data of the piece of data, and the piece of data and the adjacency data of the piece of data have a same historical access frequency; and
the adjacency data mark includes a pointer indicating the adjacency data, and data with a same historical access frequency value are linked as a frequency value linked list based on the same historical access frequency value.

17. The computing system according to claim 16, wherein the allocating the target data to the first storage area includes keeping the target data in the first storage area, and
the updating the historical access frequency mark of the target data based on the current access frequency of the target data includes:
modifying an adjacency data mark of adjacency data of the target data based on an adjacency data mark of the target data, to link upstream data and downstream data of the target data;
modifying the historical access frequency mark and the adjacency data mark of the target data, to remove the target data from a previous frequency value linked list, and adding the target data to a frequency value linked list corresponding to the current access frequency; and
modifying an adjacency data mark of current adjacency data of the target data, so that the adjacency data mark of the current adjacency data of the target data points to the target data.

18. The computing system according to claim 17, wherein the modifying the historical access frequency mark and the adjacency data mark of the target data, to remove the target data from the previous frequency value linked list, and adding the target data to the frequency value linked list corresponding to the current access frequency includes:
modifying the historical access frequency mark of the target data, to point to a frequency value corresponding to the current access frequency; and
modifying the adjacency data mark of the target data, so that:
an upstream data mark of the adjacency data mark of the target data points to tail data in the frequency value linked list corresponding to the current access frequency and a downstream data mark of the adjacency data mark of the target data is cleared, or
the downstream data mark of the target data points to head data in the frequency value linked list corresponding to the current access frequency and the upstream data mark of the target data is cleared, or
the upstream data mark of the target data points to the current access frequency value.

19. The computing system according to claim 16, wherein the moving the target data from the second storage area to the first storage area, and updating a historical access frequency mark of the target data based on the current access frequency of the target data includes:
storing a value of the target data and a key of the target data in the first storage area;
enabling the historical access frequency mark of the target data to point to a frequency value of the current access frequency;
adding an adjacency data mark to the target data, an upstream data mark of the adjacency data mark of the target data pointing to tail data in a linked list of the frequency value, or a downstream data mark of the adjacency data mark of the target data pointing to head data in the linked list of the frequency value; and
modifying an adjacency data mark of current adjacency data of the target data, a downstream data mark or an upstream data mark of the adjacency data mark of the current adjacency data of the target data pointing to the target data.

20. A storage medium, storing a cache data table, in the cache data table including first data each having a historical access frequency greater than a cache threshold; and
the first data in the cache data table having a historical access frequency mark, and the historical access frequency mark reflecting a historical quantity of times of requesting to access corresponding data from the cache data table.
wherein the first data in the cache data table is stored in a form of a key-value pair, the first data in the cache data table further has an adjacency data mark of the first data, adjacency data of the first data includes one or more of upstream data or downstream data of the first data, and the first data and the adjacency data of the first data have a same historical access frequency; and
wherein the cache data table further includes a key and a historical access frequency mark of second data whose historical access frequency is not greater than the cache threshold, the second data not in the cache data table.
